(19) United States
(12) Patent Application Publication
(10) Pub. No.: US 2009/0202687 A1
(43) Pub. Date: Aug. 13, 2009

(54) Method and Apparatus for Beverage Packaging and Vending

(75) Inventors: Thomas P. Griego, Newport Beach, CA (US); Fernando M. Sanchez, Albuquerque, NM (US); Patrick G. Bauernfeind, Mission Viejo, CA (US); Kevin J. Mello, Newport Beach, CA (US)

Correspondence Address: PEACOCK MYERS, P.C., 201 THIRD STREET, N.W., SUITE 1340, ALBUQUERQUE, NM, 87102, US

(73) Assignee: Akriya Products, Costa Mesa, CA (US)

(21) Appl. No.: 12/367,987

(22) Filed: Feb. 9, 2009

Related U.S. Application Data
(60) Provisional application No. 61/026,987, filed on Feb. 7, 2008.

(51) Int. Cl. A47J 31/44; B23P 19/00; B65D 21/00; A23L 2/52; A23L 2/72

(52) U.S. Cl. 426/238; 29/426.2; 215/10; 99/290; 426/397; 426/237

(57) ABSTRACT

Embodiments of the present invention relate to packaging and dispensing beverages.

### CROSS-REFERENCE TO RELATED APPLICATIONS

This application claims priority to and the benefit of the filing of U.S. Provisional Patent Application Ser. No. 61/026,987, entitled “Method and Apparatus for Beverage Packaging and Vending”, filed on Feb., 7, 2008, and the specification is incorporated herein by reference.

### BACKGROUND OF THE INVENTION

1. Field of the Invention (Technical Field)

Embodiments of the present invention relate to the packaging and vending of beverages.

2. Description of Related Art

The packages that exist in today's bottle beverage industry are largely blow-molded polyethylene plastic bottles (see, e.g., FIG. 1). The process of making these bottle starts with an injection molded pre-form which defines the threaded top of the bottle and has an ampoule with a volume of plastic that can be heated, and then under pressure, stretched and blown into a negative or an annular space cavity to define the shape of the bottle, thus producing a resealable, packable container. Similarly constructed bottles are available in various formulations of thermoplastics such as polypropylene, polyethylene, and Polyethylene terephthalate plastic (PET). PET is selected for its robustness and its clarity, which is part of the merchandising value of using clear bottles for water. The infrastructure for manufacturing this type of bottle is well developed. There are a number of proprietary interests for improving various parts of the technology. For example, new machinery for automating the process of molding and, of course, the core technology, which starts with injection molding of a preform and continues with a secondary process of blow molding to create the bottle.

### BRIEF SUMMARY OF THE INVENTION

An embodiment of the present invention preferably comprises a method of forming a stackable container. This embodiment preferably includes molding a piece of plastic into a predetermined container shape, cutting out the base of the container using a cutting mechanism, ejecting the container from the mold, and stacking the container onto a second container. The cutting mechanism of this embodiment can include a knife. Preferably, contents are added to the container and the base of the filled container is sealed.

Another embodiment of the present invention comprises a stackable bottle. The stackable bottle preferably comprises a bottle having tapered vertical walls to facilitate stacking, an open bottom to create an annular space facilitating the insertion of one bottle into the other creating a nestable stack, a threaded spout top, and a seal cap firmly securing the spout top. The stackable bottle preferably comprises a rounded edge around the bottom of the bottle to allow a sealing material to impress on the edge without tearing through or creating hard edges. This embodiment includes a seal for sealing the open bottom after contents are added to the bottle. The seal can be a laminated foil, a polymer film, or a co-extruded polymer seal material.

Yet another embodiment of the present invention comprises a beverage dispensing system. This system preferably comprises an automated filtration unit, an infuser for infusing minerals from a stone material into a beverage, an inverted single serve container with an open base for dispensing said beverage, and a roll seal mechanism for sealing said base of said inverted single serve container. This embodiment also preferably includes an additive infuser for adding flavors to the beverage. This embodiment may also include an electromagnet for imparting energizing qualities to the beverage and/or an ice cube maker. A second crystal infuser can also be included that allows the beverage to be exposed to both single crystal energy and analog signals of sound and images. A particulate filter is optionally downstream of the crystal infusers to assure the beverage is free of any solid materials. This embodiment may also include a grinding device for grinding the container for recovery and recycling after use or a shredding device for shredding the container for recovery and recycling after use.

A further embodiment of the present invention is a method of dispensing a beverage. This method preferably comprises the steps of filtering water through an automated filtration unit, infusing minerals into the water via an infuser, dispensing the water into an inverted single serve container wherein the base of the container is open, sealing the container base, orienting the filled container so it is upright, and dispensing the filled container. This embodiment optionally comprises adding flavors to the beverage and/or imparting energizing qualities to the beverage using an electromagnet. This method preferably includes adding ice to the beverage and/or exposing the beverage to analog signals of sound and images. The method can also include filtering the beverage after the imparting step to ensure no solid particulates are in the beverage.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 illustrates a prior art bottle;

FIGS. 2A and 2B illustrate embodiments of stackable cup-like containers;

FIGS. 3A-3D illustrate several embodiments of containers from plastic injection molded pre-forms;

FIGS. 4A-4L illustrate several embodiments of finished bottles;

FIGS. 5A-5G illustrate several embodiments of stacked containers;

FIGS. 6-8 illustrate several embodiments of stacked containers with different geometries;

FIG. 9 illustrates another embodiment of a bottle that resembles a cola bottle;

FIG. 10 illustrates a number of edge treatment embodiments for stackable containers;

FIGS. 11A and 11B illustrate schematics of purification and packaging equipment for point of sale dispensing of beverages;

FIG. 12A-12C illustrate several embodiments of purification equipment;

FIGS. 13A and 13B illustrate an embodiment of packaging equipment comprising an autoplaten sealer;

FIGS. 14A-14C illustrate embodiments of automation machinery for point of sale dispensing of beverages;

FIG. 15 illustrates an embodiment of a bottle that is bottomless and tapered;

FIG. 16A illustrates an embodiment of an array of bottles inserted into a multipack carrier;

FIG. 16B illustrates an embodiment of an array of bottles aligned under a multi-pack carrier before insertion; and

FIG. 16C illustrates an embodiment of an array of bottles aligned under a stack of multipack carriers.

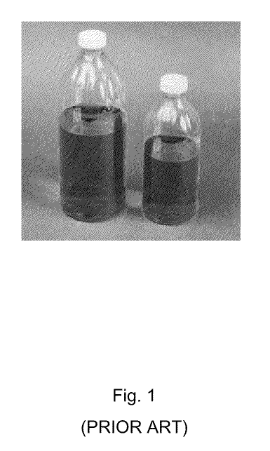

### DETAILED DESCRIPTION OF THE INVENTION

As used herein, “a” or “an” means one or more.

As used herein, “container” means an object used to hold or store material, such as but not limited to, cups, bottles, receptacles, cartons, jars, cans, bins, capsules, bags and boxes.

### Nestamug/Nestabottle

Embodiments of the present invention comprise a new style of container, which is preferably a stackable and/or nestable rigid plastic bottle-like container or cup-like container. The nested container preferably increases the shipping density with the unfilled containers to reduce the consumption of energy in transporting heavy bottles. The nested container is preferably equivalent to the dimensional weight, which would be as expensive if shipped dry. Due to the bulky volume of conventional blown bottles, the cost of transportation would be the same as filled bottles since the dimensional weight is factored in. This embodiment preferably includes a sterile, empty container stacked and packed in sealed sleeves, which reduces both weight and bulk of the shipped containers, and point of sale dispensing of water or other beverages in a vending platform or in an automated store-placed kiosk machine.

One embodiment of the present invention comprises a nestable or a stackable container that is shipped to the end point completely sealed on all but one side so that liquid is dispensed into the bottom of the container and then sealed at the point of sale.

Two popular forms of containers are largely thermoformed and generally fall into two categories. One category includes thermoformed containers from sheet material. This category is very similar to how disposable cups are made. The second category is blown molded PET. One embodiment of the present invention is based on a cup as the container. The thermoformed cups have previously been used to dispense beverages exclusively in soda fountain or fast food venues. A third category of thermoformed containers involves injection molding the net-shape of the container using specialized thin wall injection molding equipment.

In an embodiment of the present invention, the containers are nestable, high density, very low cost and are available in a variety of shapes and volumes and can be post printed to contain graphic images that promote the product that it contains. The containers are optionally fitted with a snap on lid and can be used with a drinking straw.

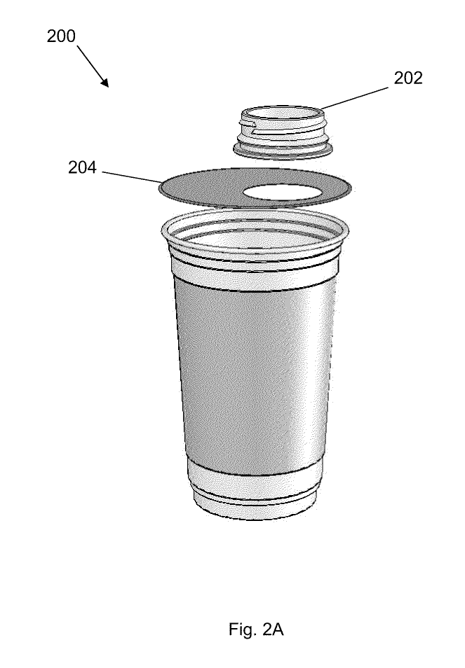

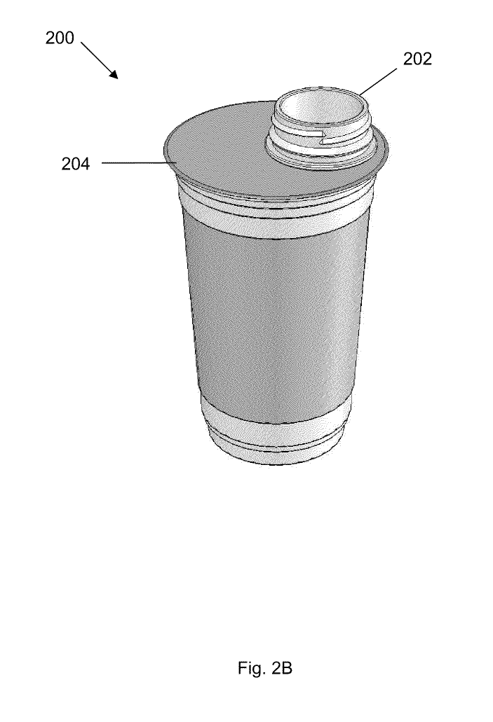

Referring to FIGS. 2A and 2B, one embodiment of the present invention is cup-like container 200 that is not spill proof and not packable so the intention of the container is for one-time consumption. This embodiment preferably comprises pre-inserted, threaded, resealable spout 202 fused to foil co-extruded film or plastic film 204, where container 200 is sealed when it is dropped into a saddle. Fusible seal-film 204 preferably with a preinstalled opening for spout 202, indexes in a thermo-sealing mechanism or other film sealing technology such as ultrasonic fusing and aligns slightly off tangent to the center of container 200 to place spout 202 close enough to the consumer's mouth to use it in a cup like fashion or to more easily facilitate pouring the contents into another container or pouring them out.

Another embodiment of the present invention creates a packable container that allows the container to be transported and packed with reasonable robustness. The container is preferably bottle-like in that it is resealable, but it is cup-like in its use which is very familiar and allows the consumer to consume beverages without having to adopt any new behaviors.

The container described in the embodiment above is preferable over squeeze bottles and flex pack bottles where the actions of the consumer must be altered to use the squeeze bottle under pressure and to be able to prevent spills with an integrated check valve to prevent the accidental spilling of the contents.

Another embodiment of the present invention comprises a thermoformed bottle, also called a NestaBottle, which comprises an inverted form of a tapered container where a spout is preferably integrated on the base of the cup. The sealing of the NestaBottle preferably uses a film, preferably a polymer film, and mechanical handling or automation for the filling process where the cup is handled specifically inverted like a bottle and sealed with a continuous fused film membrane over the bottom side. When inverted, the NestaBottle takes on a very ready, recognizable bottle shape and becomes, again, more familiar to the consumer as far as the behaviors to use this container similar to the existing practices of using a drinking bottle or using a bottle to dispense into other containers. This embodiment is preferably thermoformed from injection molded pre-forms or sheet material and is also preferably sealed with a polymer film to create a packable bottle. These embodiments are packable and robust enough to be considered a packable container and both fall in the category of being stackable and nestable so that they can be transported and, when used in a machine, can be automated to feed the queue of containers into the filling process without complex mechanisms.

The characteristics of one of the NestaBottle embodiments falls much more into the category of a blow molded bottle in terms of an aspect ratio of the shapes and are preferably somewhere around 3 to 1 in aspect ratio. The shapes are preferably designed for a personal use volume that can be held in small hands, for example, a child's hands, and are fitted with spouts that are commonly used for drinking bottles, which include but are not limited to, a screw top lid or a quick access sports top or a flip top, which can be used for drinking beverages in active environments.

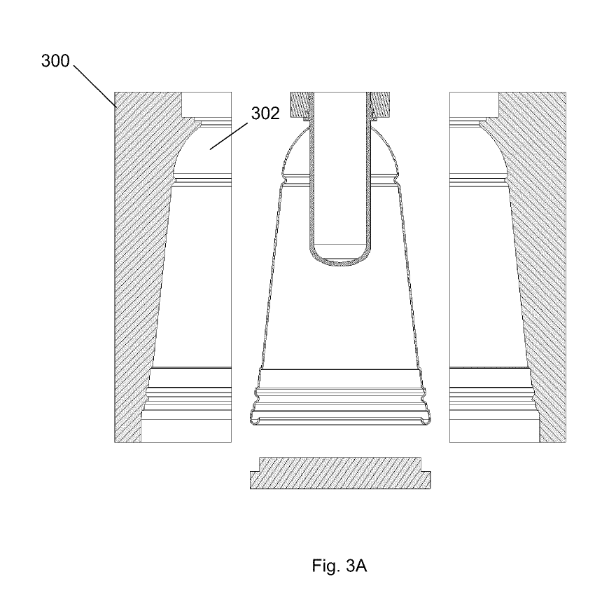

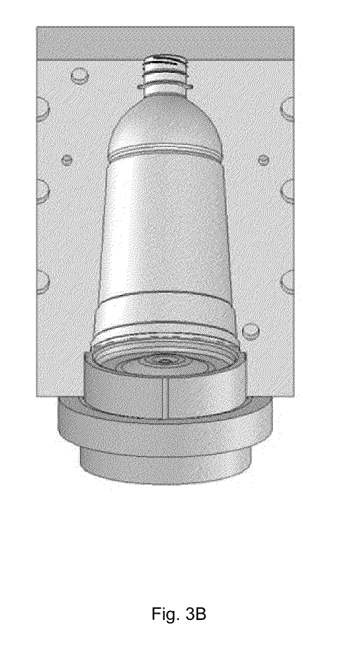

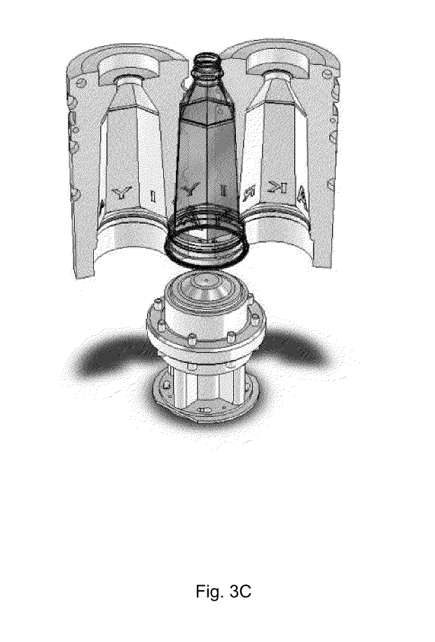

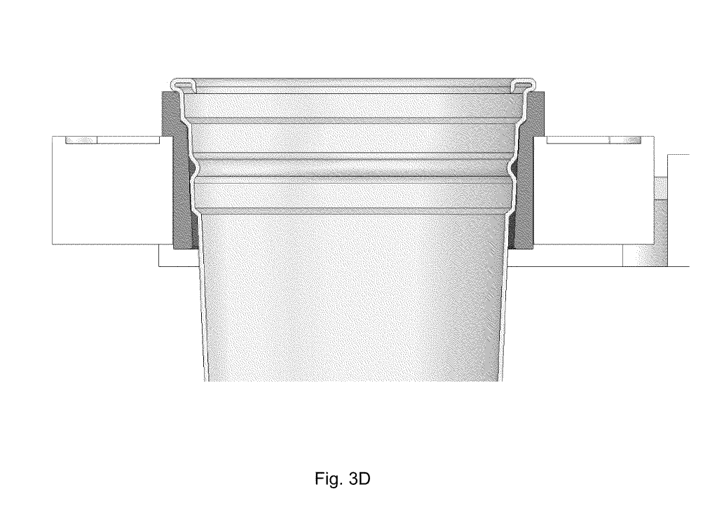

The characteristics of one of the NestaBottle embodiments create a much more familiar package form in terms of shape and clarity of plastic and, of course, the infrastructure for manufacturing the bottle. In the case of a NestaBottle embodiment, a plastic injection molded pre-form is preferably utilized. FIG. 3A illustrates pre-form 300 and at the center an unexpanded, preformed container. Behind, in silhouette of FIG. 3A, a form of bottle 302 that would be created with conventional blow molding methodologies. FIGS. 3B and 3C also illustrate pre-form bottle mold assemblies for different shaped bottles. FIG. 3D illustrates an exploded view of a pre-form bottle mold assembly showing an edge treatment of a bottle.

Pre-form 300 preferably defines a threaded drinking spout (not shown) and is available in a variety of sizes that are designed for both active users and also for more comfortable drinking with wider mouth spouts.

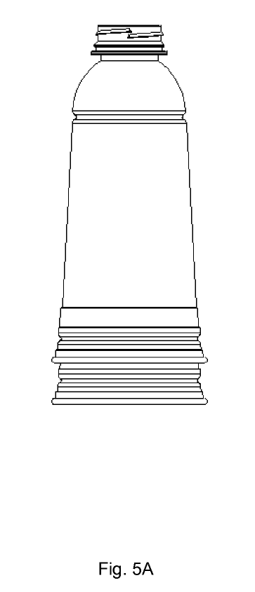

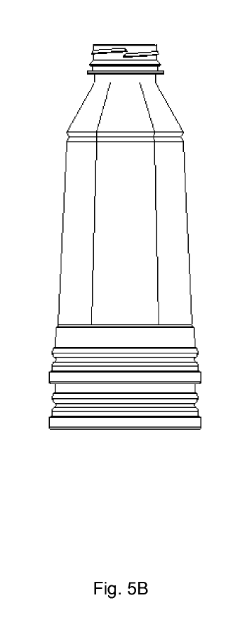

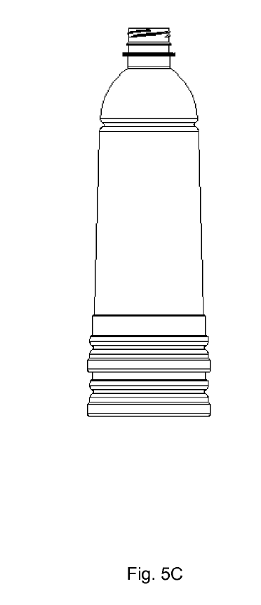

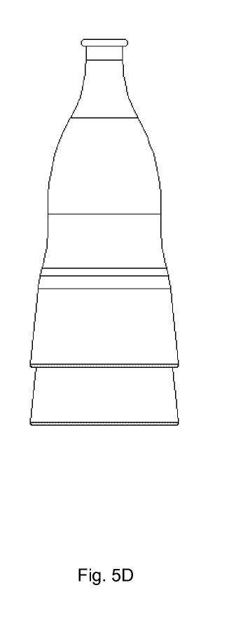

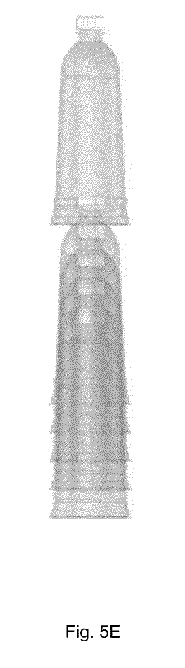

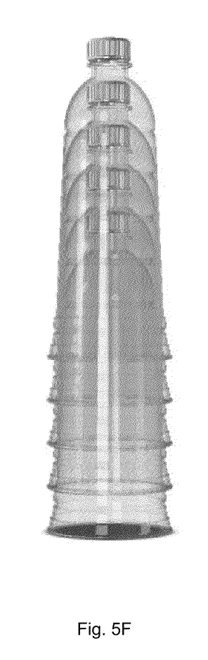

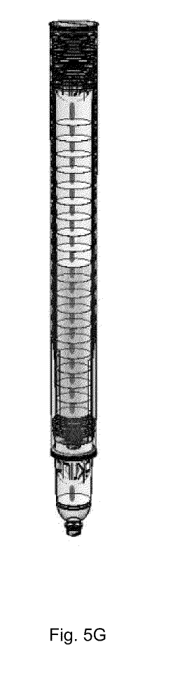

The supply of these injection molded pre-forms includes a supply of caps that are mated to pre-form 300 and to the finished bottle. The bottle itself has two characteristics that are unique compared to existing blow molded bottles. First, there is a taper to the vertical walls of the bottle. This taper facilitates the easy nesting, which is illustrated in FIGS. 5A-5G. Second, the bottoms or base of the bottles are open.

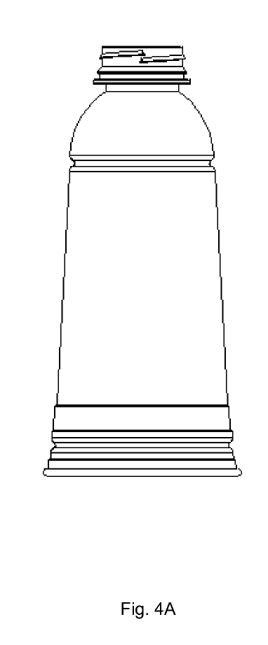

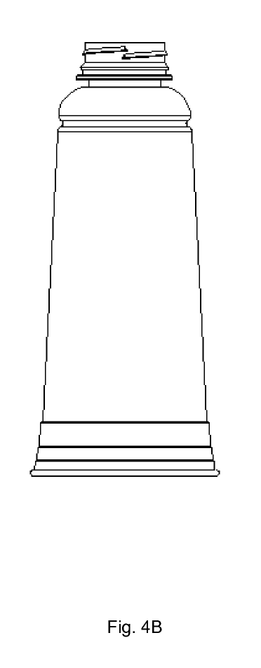

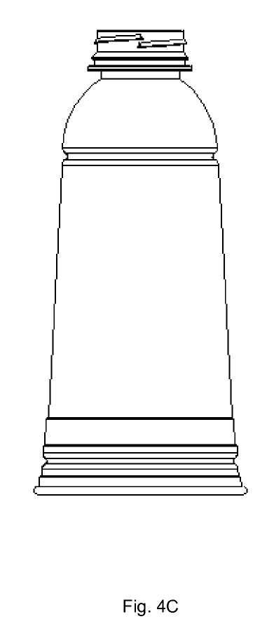

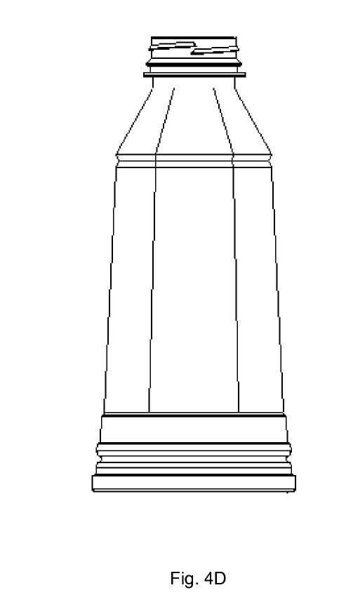

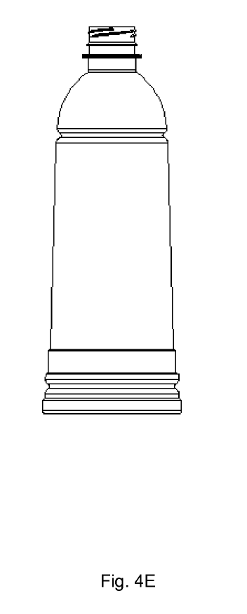

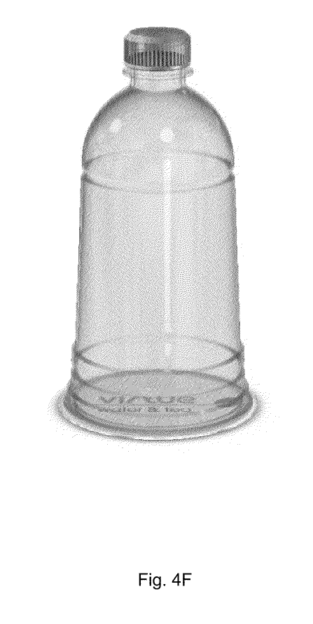

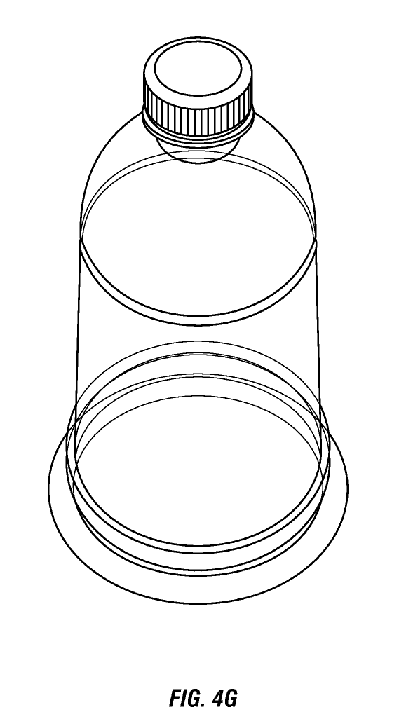

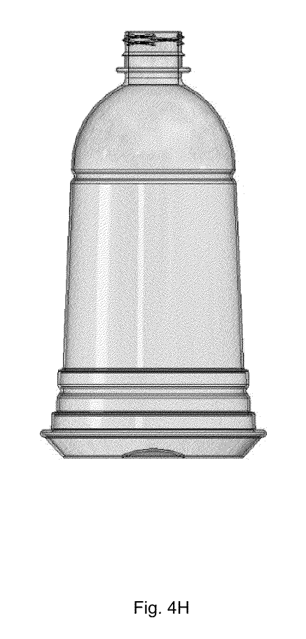

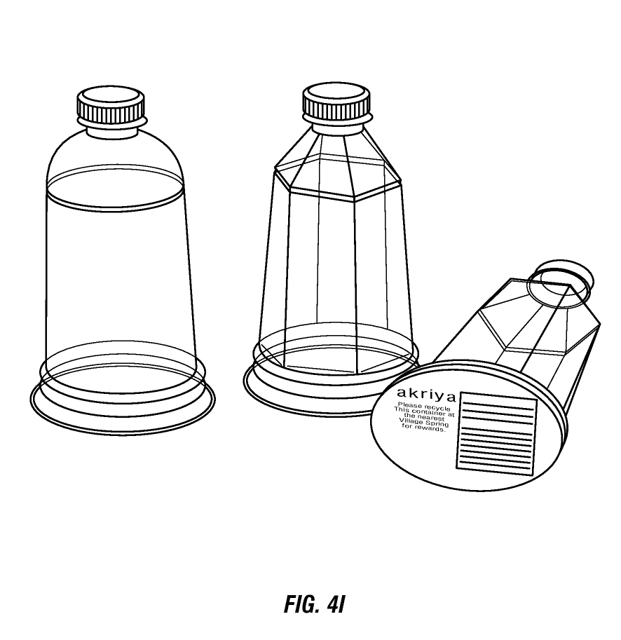

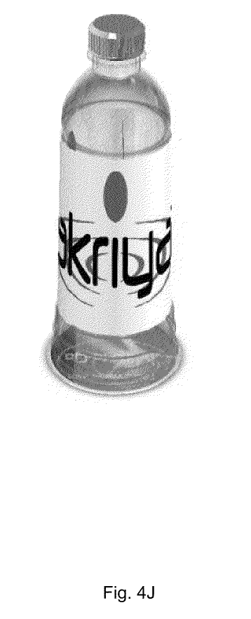

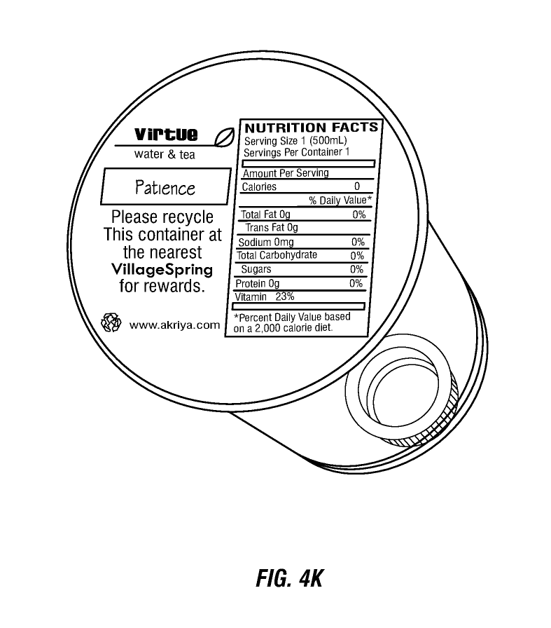

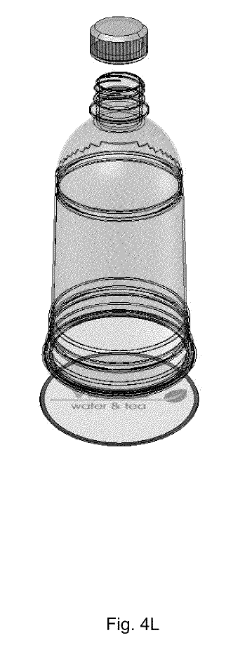

Embodiments of the present invention are illustrated in FIGS. 4A-4L and FIGS. 5A-5G. FIGS. 4A-4L illustrate different shapes and different views of finished bottles and FIGS. 5A-5G illustrate NestaBottle containers stacked on top of each other demonstrating a very efficient use of space and a very consistent pitch between the attachment points for automating the handling of the preferred containers. FIG. 5G illustrates several stacked NestaBottles in the inverted position ready to be filled.

The mechanism for handling containers is preferably an index pitch mechanism or a gravity and gated separation where gravity drops for actuating the movements of the containers. The NestaBottle's production is preferably done on conventional bottle thermoforming machines. The molds for creating the open bottom and the tapered sides are described below.

In yet another embodiment of the present invention, the bottom of the containers is finished with rounded edges and with a flanged lip that extends beyond the annular cavity. The bottom of the container is also preferably completely open creating an annular space facilitating the insertion of one container into the other creating the nestable stack that is important for shipment and automation of filling the containers. The open bottom of the container is preferably the end that is filled. So, in this embodiment, on the opposite end of the opened bottom is the threaded or injection molded threaded spout top preferably with a seal cap firmly secured and ready to be used by the consumer from the pour spout end.

In yet another embodiment of the present invention, the mold for making the NestaBottle bottle is preferably adapted to existing bottle thermoforming equipment. The design rules for creating the mold follow the same design rules as a standard PET blow molded bottle with one important exception. In this embodiment and unlike conventional thermoforming equipment, there is a three piece section to the tool. The primary tool is a clam shell or two halves of the bottle with the desired shape of the bottle recessed in the block of the mold. The base of the mold in the present embodiment would also be part of the two half of the clam shell of the mold, but the bottom of the mold preferably has a break away circular base that has disposed within it a cutting mechanism that is actuated immediately after the bottle is blown to its desired shape. The bottom actuates the cutting mechanism, which cuts out the bottom or the floor of the bottle, and under vacuum, retains the floor piece and pulls the core out before the bottle is released.

The cutting mechanism that is used in an embodiment of the present invention is preferably heated to provide a burnishing or a polishing of the edges and leaves the bottom without any debris particles or burs remaining because of the thermal treatment on the edges. The expected edge finish is preferably safe for handling and safe for food service.

In a further embodiment of the present invention, the three-part tooling for manufacturing the NestaBottle bottles preferably comprise additional actuation to open and close the mold and release the finished bottle and to also release the cut away plug from the bottom of the bottle. The portion of the bottle that was removed from the main bottle's shape is domed and is retained for use and replaced on a film carrier and resealed in the bottles.

The axis of the bottom of the mold is a vertical “z” axis. There is a secondary axis, which is the rotation of the cutting mechanism to cut the bottle, and this is done by a number of methods. In one embodiment, the cutting mechanism is a knife. In this embodiment, an approximately 60 degree actuation requires a total of six knives. An approximately 180 degree motion requires two knives, and this allows for actuation of the rotation axis to free the bottom piece from the bottle with existing market available components.

In another embodiment of the present invention, the bottles are blow-molded in the conventional process rendering a taper-bodied bottle with the external lip as the major diameter feature. Subsequent process steps are preferably used to remove the bottom plane of the bottle using a stand alone spin cutter designed to cut cylindrical containers. This operation results in a right angle radial flange extending outward. The bottles are then preferably stacked and processed with rolled lips using a thermal screw lip forming machine employed in making thermoformed cups. The final result is preferably a smooth right angle lip that is reinforced by a rolled geometry and ideal for sealing with a fusible film.

The bottle, after being formed and the bottom removed, is then ejected from the mold using methodologies known in the art.

The bottom of the bottle is now open, and the bottles are preferably stacked and kept in a clean and sanitary environment and are preferably sleeved in plastic in order to keep the bottles clean for use in drinking beverages. The basic requirements of the manufacturing process are established by the practices of the Food & Drug Administration, and the bottle itself is manufactured according to such requirements. The spout tops are preferably a secondary operation for assembly, and this is either done manually or using automated equipment known in the art.

Once the NestaBottle bottle's spout tap or screw lid are attached and torqued, then the bottle optionally goes into a final packed sleeve and is stacked in convenient quantities that support use, including use in automated equipment.

The range of design for this type of container is quite versatile and is amenable to marketing or merchandising schemes for multiple brands and multiple end user interests.

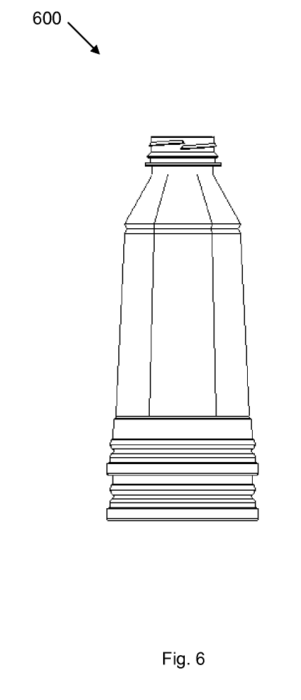

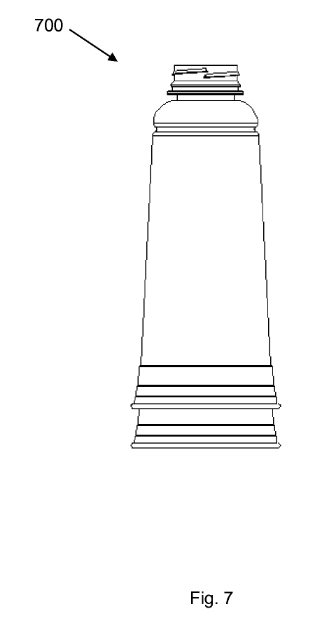

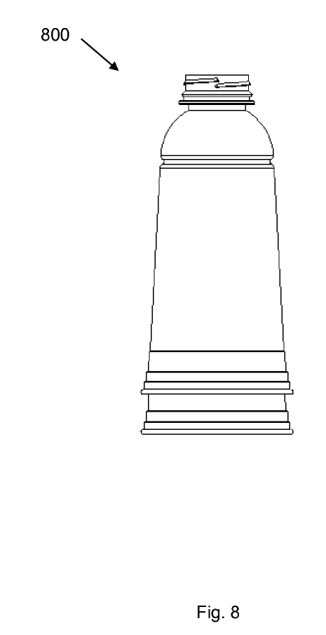

FIGS. 6, 7, and 8 illustrate a stack of three different embodiments of containers with geometries ranging from faceted bottle 600 in FIG. 6 to high shouldered bottle 700 in FIG. 7 to slope shouldered bottle 800 in FIG. 8 all having very distinctive unique aesthetics that allows the industry to create bottles to handle a number of different products and create a number of different effects to support the interests of a beverage brand.

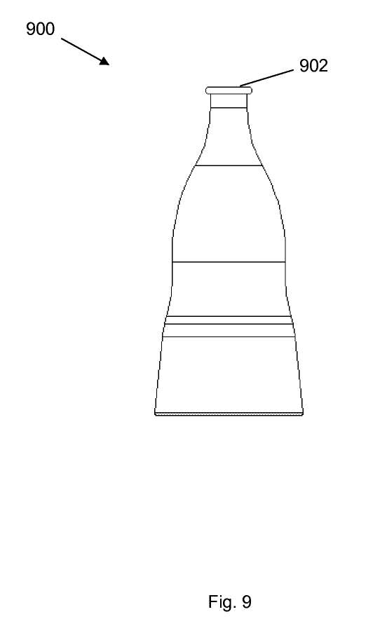

FIG. 9 illustrates yet another embodiment of bottle 900 finished with screw-type spout 902 and more of a rolled lip, crown cap associated with bottled beverages of the past. This type of bottle is also stackable and can be used for dispensing carbonated beverages that allows the point of use dispensing of the container into branded shaped bottles that maintain the brand equity in this new process of packaging.

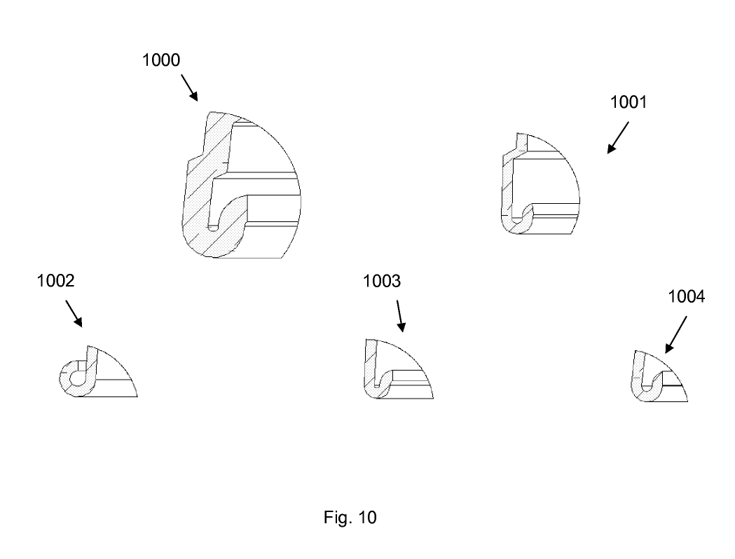

FIG. 10 illustrates edge treatments 1000, 1001, 1002, 1003, and 1004 that are attainable by thermoforming or by blow molding which is the detailed feature at the base of the bottle where the seal is made. The characteristics of edge treatments 1000, 1001, 1002, 1003, and 1004 is to have a bull nosed or rounded feature over an edge to allow the sealing material to impress on the edge without tearing through or creating hard edges that would eventually propagate failures, such as rips or ruptures, in the final sealed product.

At least three different types of sealed bottoms can be employed that have various capabilities in handling beverages under pressure, the pressures resulting from either the product itself, such as a carbonated beverage, or from atmospheric and temperature changes, such as altitude changes or being aboard an airplane or some other exterior pressure that would cause the contents of the container to billow out and for the bottom to become rounded over and make the container unstable and wobbly.

The simplest embodiment used for the sealing of the bottom of the containers is a laminated film seal material. The laminated film seal material is an easy material to use. However, it is the most susceptible to atmospheric and temperature changes. And the expected result would be that the bottom would alternately contract and expand and would create an effective but not desirable container seal.

A second embodiment used for sealing the bottom of the containers is the recovered centerpiece, which is made out of the same rigid plastic that the bottle was formed from. The centerpiece is preferably then reassembled and aligned off of a roll form that would allow the material to be automated in the preferred point of use or point of sale equipment.

A third embodiment used for sealing is preferably made from rigid material that is still of a thin enough gauge to be handled in roll form. This comprises a pre thermoformed reel of dimples that were thermoformed in the film and then indexed on a fixed pitch to align with the bottom and create the reinforced dome or inverted dome bottom closure that is more aesthetically pleasing and able to withstand the changes in temperature and atmospheric pressure. This embodiment also creates a much more bottle like appearance and ultimately is used in a re-torqued fashion where the contents are filled into the container under pressure, and the resulting negative pressure creates an axon internal pressure and collapses the bottles.

This third embodiment makes the bottle packaging system more consistent with the best designs of PET blow molded bottles. This embodiment allows the ability to automate an index in the reassembly or the final assembly of the lid. It also allows for die cutting the finished bottom piece in one stroke where the base plate is welded on and die cut simultaneously would result in a very consistent concentric placement of the dimple with a very uniform seal based on the laminated thermal film layer laminated to this roll of dimpled material. So, in this embodiment, each one of the characteristics of the bottom is welded in as the final step using thermal techniques.

In another preferred embodiment, the NestaBottle bottles are blow molded using thermoforming techniques. However, the process of injection molding a bottle or container can also be used and uses the same design roles with the tapered vertical surface or the tapered vertical geometry. Some features, such as ribs that would be internal to the device, would have to follow under different design rules, such as using a thicker material because the groove couldn't translate into the internal cavity without being trapped in the molding process.

The potential and the desirability of injection molding this type of container is very high for packaging beverages, such as milk, juice, and other liquids that don't benefit from the higher cost clear or crystal clearness of PET bottles, but this technology and this methodology would certainly be usable in that same fashion, including injection molding with polypropylene or polyethylene using the same types of materials, the films and laminated foils for sealing the bottoms.

In one embodiment of the present invention, a bottle-like container is preferably nested for transporting and uses an automating filling process. The filling process for the bottle-like container is done in a wide open area. For a cup-like embodiment, the cup is oriented in the correct upward orientation, which is the same orientation for drinking or dispensing the contents. The NestaBottle bottles, however, are filled and automated in the upside down position with the bottom of the container directed up to receive the dispensed liquid and also to align with the sealer and receive the seal.

Once the seal is in place, the containers can be oriented in any position and, of course, are completely packable. The materials used for all of these containers are preferably some form of thermoplastic. Thermoplastic in almost all cases for the bottles are preferably uncross linked polyethylenes or polypropylenes. However, it is conceivable that a certain amount of cross linked material is used and, of course, bi-axial oriented PET or BOPET materials are a preferred material for use in producing any of these bottles.

The utilization of corn derived polymer materials also falls within the manufacturing processability for this type of container.

### Machine For Dispensing Beverages

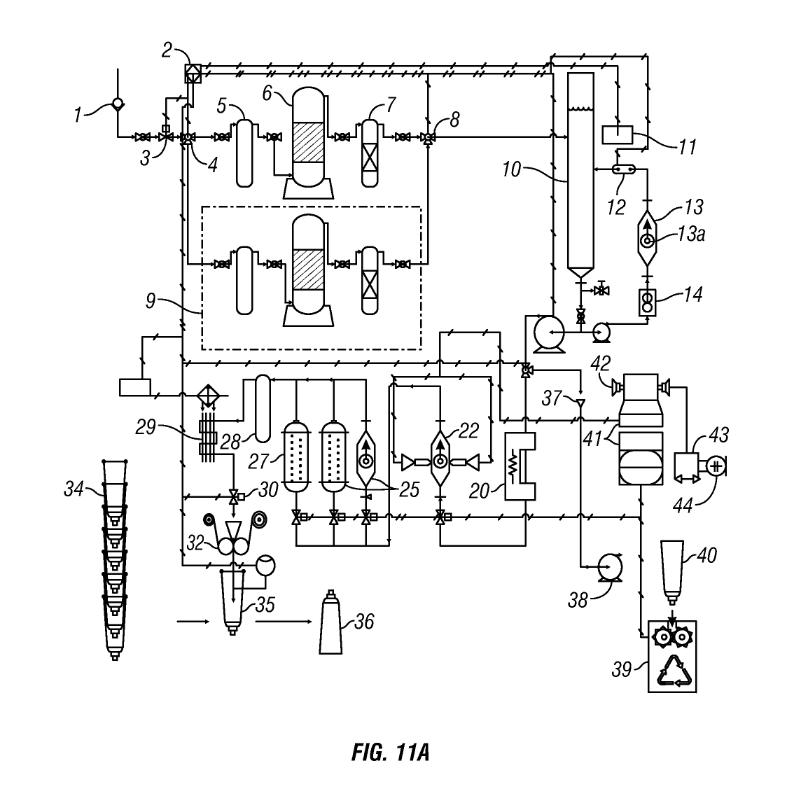

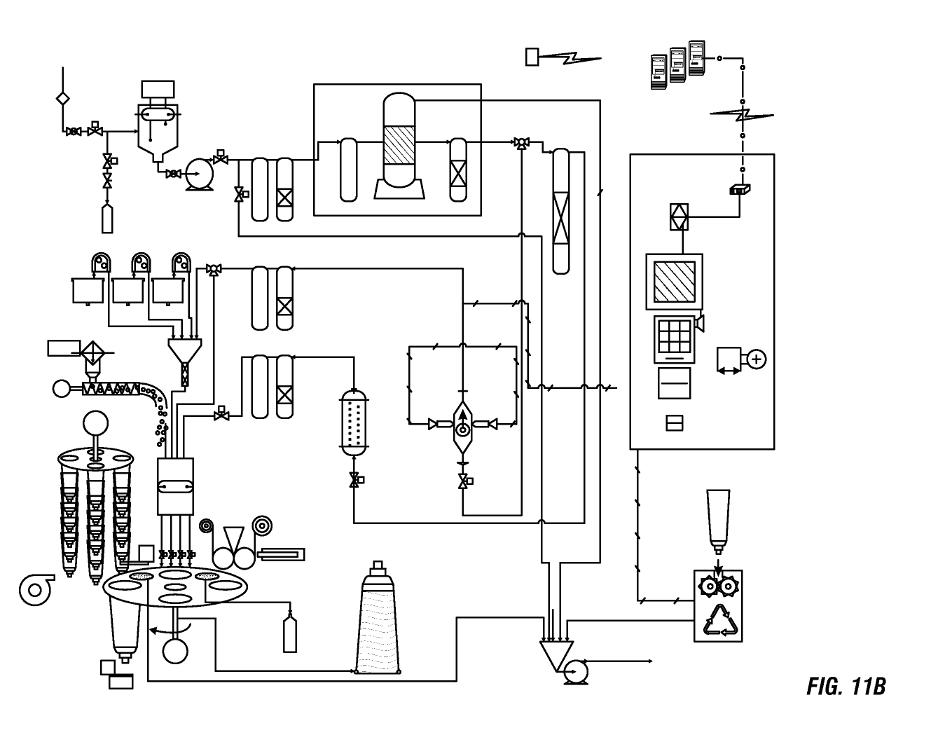

One embodiment of the present invention comprises automation machinery for point of sale dispensing of beverages. FIGS. 11A and 11B are schematics of a system for purification and packaging equipment for filling and dispensing stackable, either flexible and/or stackable beverages including but not limited to bottled water, teas, juices, lemonades, or soft drinks. The beverages are preferably made from tap water that is piped to the system at the point of sale. Since this embodiment preferably uses tap water, the first step in the automation process is to use filtration to remove the dissolved solids and other organic species in the water that would affect the taste, purity, and quality of the water. The automation machinery for point of sale dispensing of beverages can optionally comprise a sampling system for sampling the tap water to ensure optimum purification of the tap water.

In a well controlled community where the water is regulated by some government entity to assure the safety for the public, the water is preferably utilized directly from the tap. In countries where the infrastructure for supplying water to citizens is not as advanced, pre-treatment equipment can be utilized prior to the machine to assure that the water's softness and to address possible viral or pathogenic species before going into the primary equipment.

FIG. 11A comprises check valve or anti siphon valve 1, which protects any back draws from the system into the tap water in the case that negative pressure would occur in the pipe from either a break or an interruption in service. A scheme that illustrates redundant loop 9 for the pre-treatment process is also illustrated on FIG. 11A. Programmable logic controller (PLC) 2 preferably manages the process and controls all the valves in an automated, unattended fashion to assure the highest quality and safety of this system. Electronic shut-off valve 3 interlocks the system by shutting down the incoming water and preventing either flooding or service of the water in the event of some failure.

Valve 4 of FIG. 11A is preferably a three way valve, which directs water through one of the two parallel pre-treatment systems to assure the highest quality of the water between servicing the pre-treatment filters.

Particulate filter 5 is preferably a 1-20 micron scale membrane, and more preferably a 5-10 micron scale membrane and most preferably an approximately 7 micron scale membrane that removes incoming solids from the system, including sand, oxide particles and other debris that might be present in the water.

FIG. 11A further comprises reverse osmosis column 6 that removes the volume of dissolved solids through reverse osmosis. This treatment is preferably used for addressing elements including but not limited to sodium, mercury, chlorine, and a number of other elements that would be either detrimental to health of the consumer or would contribute to poor taste in the water.

Activated carbon filter 7 of FIG. 11A acts as a carbonatious attachment point for any type of organic material that would be in the water. The organic material could be both dissolved solids and particulates. The result is that the water flows through the system free of sulfur and other odor or taste affecting elements.

Three way valve 8 extends the time between servicing by switching over to redundant pre-treat loop 9.

Cylindrical cistern 10, which is preferably sized to accumulate the pre treated water, allows the system to make water continuously without having to size the equipment to meet demands. So, cistern 10 allows the balance of the equipment to be much smaller in scale and to provide a much more economical utilization of the filtration by allowing lower feed flows to accumulate in cistern 10 to meet the demand at the point of dispensing.

Level controller 11, is a gating device to maintain optimum cistern 10 levels. Because the pre-treated water is stored in the system, the pre treated water is continuously circulated through ultraviolet light 12. Ultraviolet light 12 prevents organic species from colonizing and reproducing so that algae and other types of mold spores do not have a nurturing environment to proliferate.

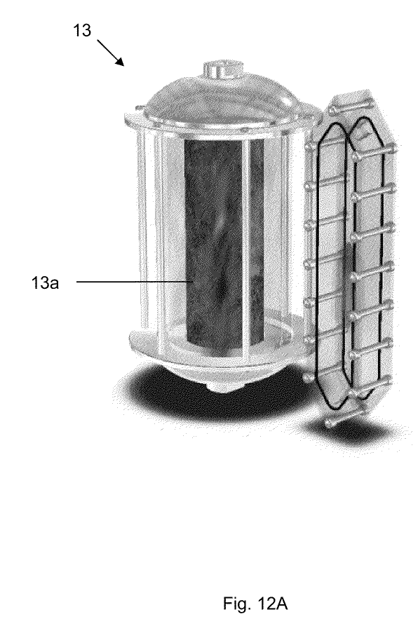

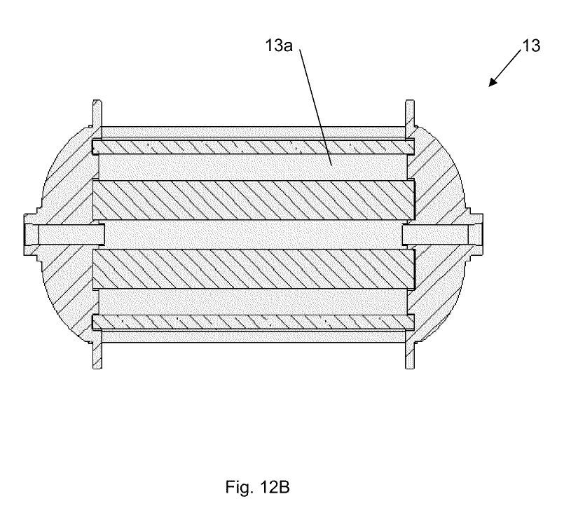

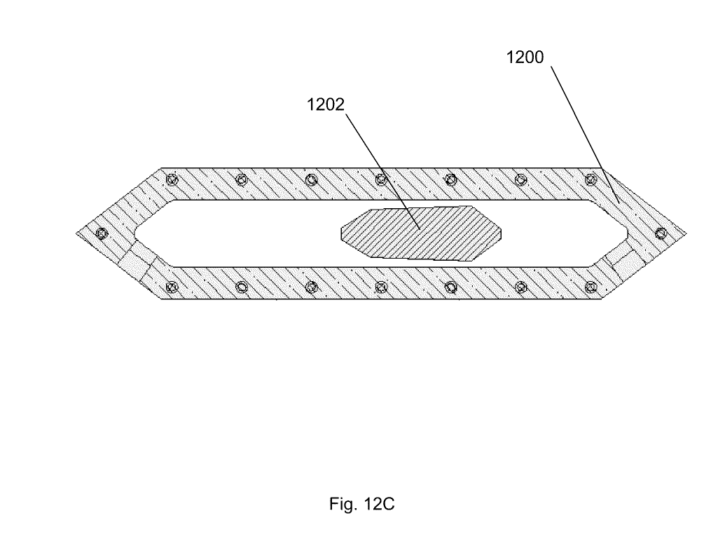

Infuser 13 is preferably mineralization equipment designed to erode or dissolve solids into the water from a stone or crystal material, including but not limited to calcium fluoride which has health benefits for bones and teeth. Infuser 13 is dependent on continuous flow to achieve an appreciable amount of the mineral to be effective in the treatment process. FIGS. 12A and 12B illustrates infuser 13 comprising stone or crystal material 13a. FIG. 12C illustrates another embodiment of an infuser; this mineralization equipment comprises chamber 1200 and stone 1202.

Flow meter 14 gauges the incidents of exposure since crystal infuser 13 requires a known volume and impingement velocity to accurately calculate any type of process control for the rate of inclusion of the material, primarily for slow dissolving materials. Infuser 13 is part of the pre treatment portion of the system. After this point in the system, the water is considered a pure, standardized water. At the point of sale, the consumer approaches the mechanism, which is preferably either a coin operated vending machine or a button operated point of sale kiosk in a retail outlet, and makes a selection.

The machine preferably has a range of enhancers that introduce various intrinsic properties, mineral substances, or flavorings to enhance the water's drinkability and to enhance the nourishing value on a spiritual or metaphysical level. After a selection is made by a consumer, water from cistern 10 is circulated through the enhancing section of the system. The enhancing section has a number of infusers that can be used for introducing crystal resonance to the water for improving the water's energy levels.

Electromagnet 20 in FIG. 11A can be coupled to varying amplitudes of electrical currents and varying pulse switch or pulsing time waves of current that imparts energizing qualities to the water by polarizing the molecular structure of the water. Infuser 22, preferably with analog transducers attached, allows the water to be exposed to both single crystal energy, as well as analog signals of sound and images that can also be injected into the water stream as it flows through the piping. Selectable crystal mojo-infusers 25 are preferably where various mineral substances, such as single point crystals or sedimentary rock are used to allow the purified water to strip elements from the composition of a terra stone, such as limestone, dolomite, travertine, or marble imparting a flavor to the water by absorbing dissolved elements, such as magnesium, silicates, bicarbonates, and other types of elements that are found in Artesian well and water aquifers and are generally the source of intrinsic flavoring of bottled water, such as Fiji or Pellegrino, or Perrier, which have absorbed the characteristics of the earth around an aquifer. In one application, by first removing or purifying all of the elements in the purification of the water, the water's solvent-like qualities make it aggressive enough to strip elements or strip metals from the infusers to create favorable and safe flavoring enhancements to the water resulting in a mechanized process for creating naturally mineralized water without using titration or chemical analysis or other complicated schemes to provide additives to the water. Additive or flavoring infuser 27 introduces syrups or powders to enhance the taste of water or to change the water to a flavored ready-to-drink beverage, tea or sports drink.

Sub micron particulate filter 28 follows all of the infuser steps to assure that the water is free of any solid materials that might break away from the natural stone used in the infusers.

The stones used for infusing the minerals are preferably found in limestone or rock formations, fabricated into the desired shape, which is preferably a tubular formation much like a filter cartridge or a pipe, to allow incidents of exposure to be based on time and velocity in a capsule-like or tubular vessel. The stones can also be fabricated via concrete aggregated methodologies or synthesized through a ceramic process like the process used to make zeolite or zeolite cores.

After the water has been enhanced, it then flows through heat exchanger/ice cube maker 29. The open bottom nestable container is preferably large enough to receive ice cubes. Other solids can also be introduced into the water, such as, but not limited to, cereal and jelly balls.

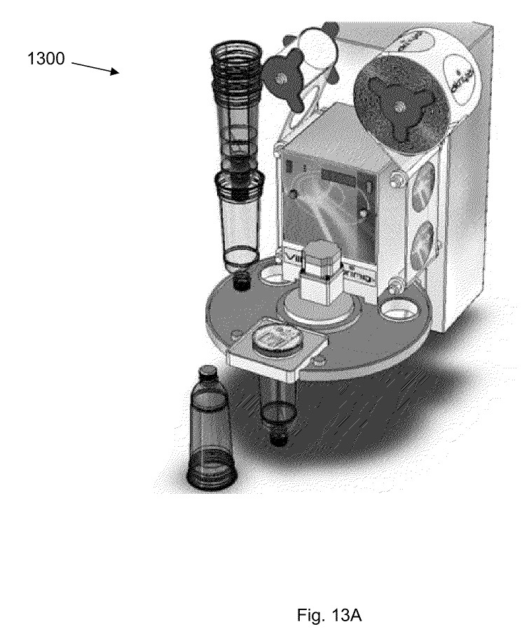

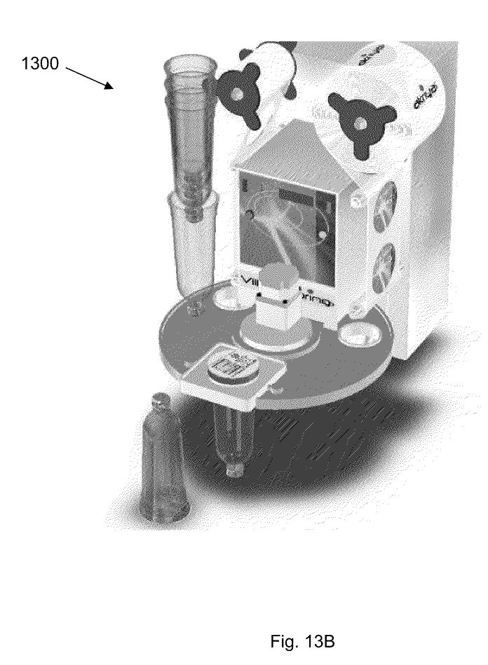

Control valve 30 of FIG. 11A is regulated to dispense the appropriate portion of water or beverage into the container. Roll seal mechanism 32 welds or fuses the barrier seal film or the dimpled thermoformed sealed bottoms onto the base of the container. Referring to FIGS. 13A and 13B, autoplaten sealer 1300 is preferably used to fill, seal and label stackable containers.

Empty inverted single serve container 35, as illustrated in FIG. 11A, is a container being processed, while nested container queue or magazine 34 has the stacked containers ready for dispensing. Finished, filled, and sealed container 36 is ready to be served to the consumer.

Drain 37 drains the reject stream water coming from reverse osmosis equipment 6 and also purges, cleans, or dumps cistern 10 in between servicing. Lift station drain pump 38 allows the machine to be more freely installed without the necessity of a gravity drain and large diameter drainage piping. A small diameter hose is preferably used with pressurized pump 38 for lifting and transporting the discharged water convenient distances.

Integrated grinding or shredding mechanisms 39 and 40 allow the specific package, either a flexible package or the nestable containers, to be shredded and ground up for recovery and recycling. The grinding and shredding of the nestable containers increases the density of the reclaimed or recycled container, making it easier to transport and making it safer for the service technician to handle via a bagged, shredded end product. Mechanisms 39 and 40 also allow a store operator to be free of involvement in a recycling program; therefore, improving the efficiency of the infrastructure for handling the recycled containers, making it easier for the consumer to participate and the retailer to support the entire recovery of all the empty containers.

Consumer selection interface 41, preferably uses stereo speaker 42, digital recorder 43 and digital microphone 44 to interface with the consumer. This is where the consumer makes their selection and where music and images are introduced into the system for additional intrinsic value in the crystal image infuser or sound and image wave infuser. This embodiment, as illustrated in FIG. 11A, constitutes a preferred embodiment of the system. The present embodiment optionally comprises other treatment systems, including but not limited to, deionized water and distilled water processes that find use in this same schematic and can be included depending on the economics or consumer preferences that govern the ultimate configuration of the system.

The machines, embodied in FIGS. 11A and 11B and used for point of sale, have the ability to take unused, flat pouches or nested cups and dispense water or other beverages into them, and completely hermetically seal the container and serve to the consumer in a single serve form or be coupled to a pelletizing mechanism which would allow for accumulation of single packages and package accumulated containers in convenient six packs or 24 pack cases for bulk sales.

The mechanism for the package can range from conventional cartons, which can be a matrix of cavities in a carrying container or a sleeve with holes that can receive the containers in a snap in fashion and make it easier for the consumer to carry. Embodiments of this invention provide a filtered, purified, and enhanced water without transporting the water via truck, plane, or ship, and provide a much more responsible utilization of the natural resources and takes advantage of the infrastructure of water in developed countries where water is delivered to every citizen's home or place of business via a network of pipes. Embodiments of the present invention supply a consumer product and increase the efficiency of supplying beverages by utilizing a micro-bottling plant that eliminates the handling and labor costs and the transportation costs in a fully, unattended, automated platform.

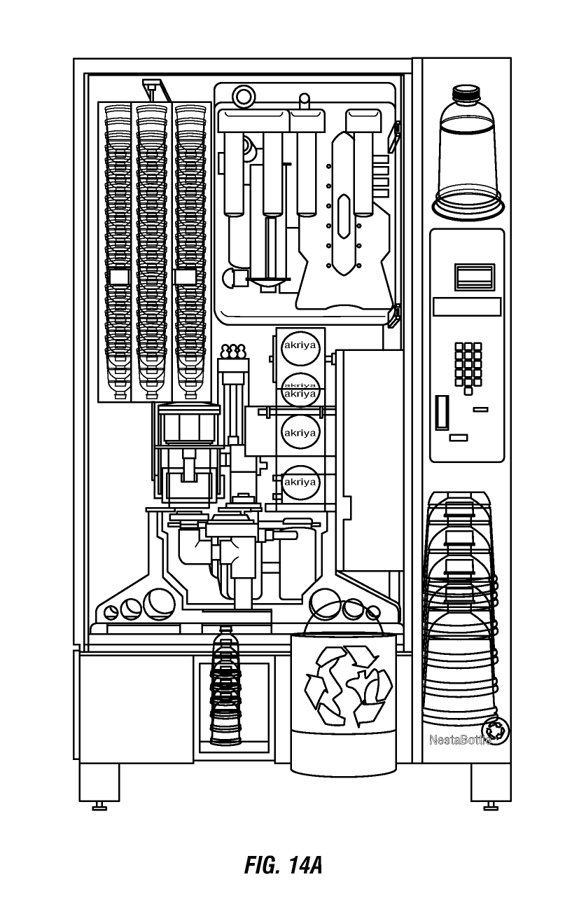

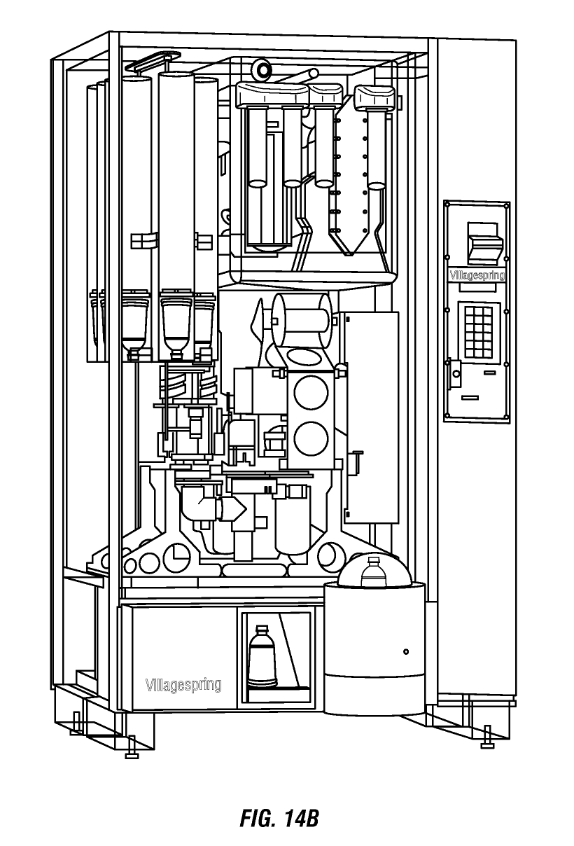

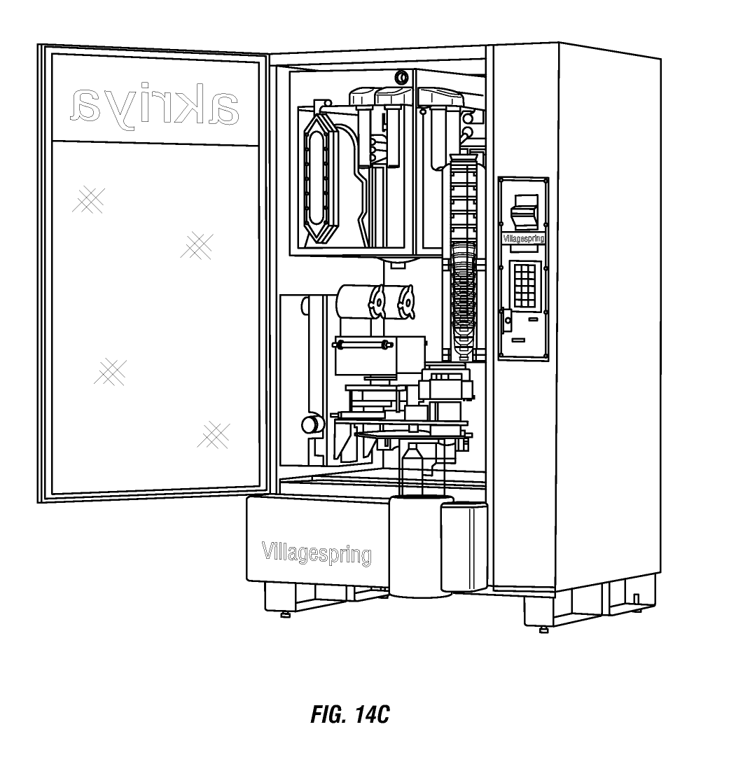

FIGS. 14A-14C illustrate embodiments of the present invention comprising automation machinery for point of sale dispensing of beverages. The automation machinery of these embodiments preferably house the purification and packaging equipment as described above and illustrated in FIGS. 11A and 11B.

### Packaging Single Bottle Containers Into Multi-Packs

Another embodiment of the present invention comprises a package form, equipment and method for packaging single bottle containers into multi-packs of, for example, 6, 12 or more.

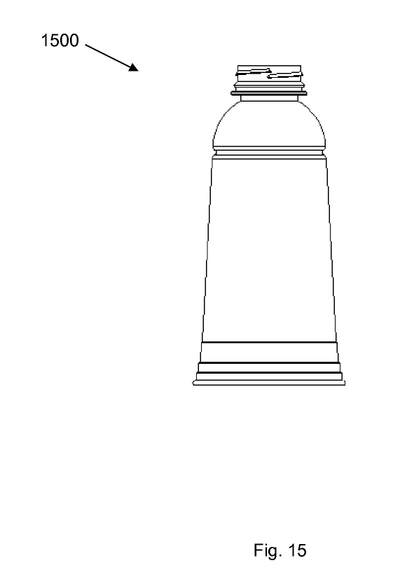

FIG. 15 illustrates container 1500, which is preferably a bottomless, tapered or nested container. Container 1500 preferably comprises tapered vertical walls and an open bottom. At two placements in the vertical wall are radial grooves that are preferably molded in around at the shoulder of the container and at the base of the bottle. These grooves are used for automated handling. They also contribute to the aesthetics of the bottle, and they also, with their convoluted features, improve the robustness of the bottle by reinforcing it with rib structures. At the top of the container is the threaded spout with a concentric collar at the shoulder.

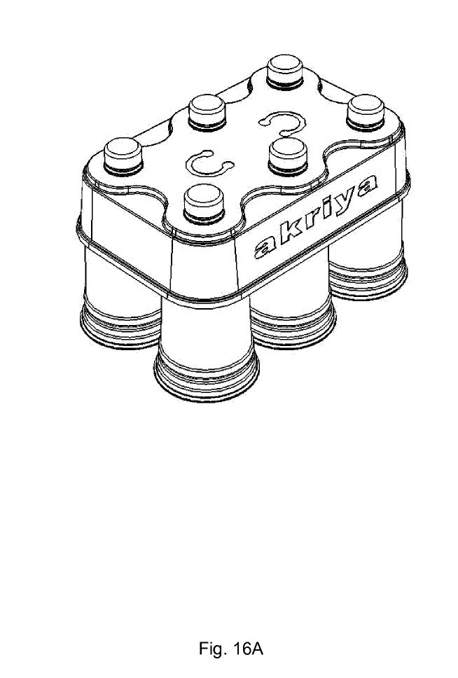

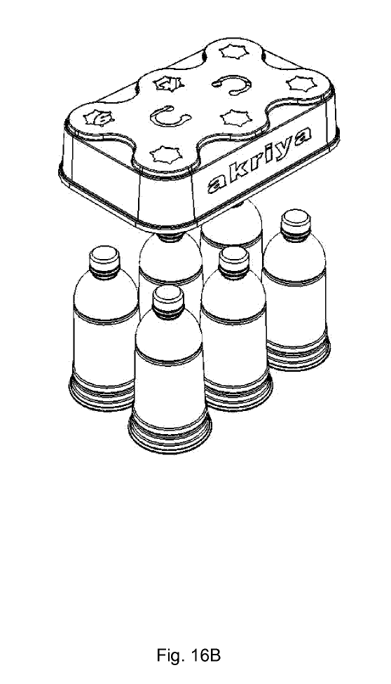

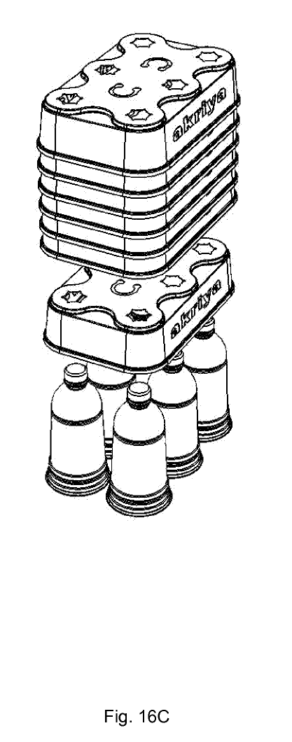

An embodiment of the present invention is illustrated in FIGS. 16A and 16B. This embodiment comprises a method of creating multi-packs of filled beverage containers using nested thermoformed plastic bottle carriers known in the art. These carriers are preferably de-nested, aligned and snapped in place to hold six bottles gripped under the collar at the bottles upper shoulder. FIG. 16C illustrates a tapered, stacked and perforated carrier preferably coming from a sleeve or magazine showing an array of holes that align concentrically with each finished single serving container accumulated in rows.

In one embodiment of the present invention, a finished packaged single beverage container is introduced through the bottom of the machinery until the radial collar on the shoulder of the container aligns with a carrier. The single beverage container then preferably snaps into the carrier holes thereby locking the container in place and also creating right angle gussets to reinforce the multi-pack carrier making it completely self standing. The carriers are preferably prefabricated and then shipped, stacked, and handled nested, and then in the final step de-nested and aligned to create a modular array of single bottles conveniently handled and merchandised as a multi-pack product so that the entire process of creating multi-packs is efficiently manufactured and transported and handled in a very high density fashion with the least amount of complexity for creating the crate.

The carrier can optionally be used to merchandize and to transport the product after the point of sale for carry out to the consumer's home place or workplace or other destination. The materials of construction for the carrier and sleeve can include, but are not limited to, paper, cardboard or recycled plastic sheet material. These materials are selected for rigidity and recycling compatibility.

An enhancement for the holes that lock the containers into place is also illustrated in FIG. 16C, which can be a radial array of cleats that more effectively allow the consumer to eject the containers from the hole that is retaining the groove.

### Water Treatment Process Recipe

Another embodiment of the present invention comprises a water treatment process recipe. Today's marketplace for bottled water is largely driven by a perception of safety and a desire for better tasting water in convenient containers.

The existing bottled water market is comprised of source waters, which are generally found in locations that are located in natural Artesian springs or natural water aquifers that have been tapped either via pumping or that flow to the surface under Artesian pressure or some other methodology.

The characteristics of these waters are that they are source specific in that the water's quality, the intrinsic value of the flavor, and any nutrition or other values imparted come from the surroundings of the water aquifer.

Another type of bottled water is purified water that has been mechanically processed to remove dissolved solids, particulates, and organic species that detrimentally affect the water's flavor, taste, smell and visual qualities. These waters are packaged locally and distributed via trucks to markets in clear plastic bottles.

A third classification of bottled water is called enhanced waters, and these are waters that have been pre-treated for purity having various elements and organic species removed to improve and standardize quality. Enhanced water also adds flavorings, other mineral contents, and electrolytes, such as salts and minerals and metals that are selected for contribution to the diet of the consumer and can be a source of vitamins. These waters claim to enhance athletic performance and are often used as a hydration replacement. A number of brands of these waters are created specifically via process recipe or proprietary recipe.

An embodiment of the present invention comprises a new methodology for creating an enhanced water, a spring water and/or a purified water, and dispensing the water on demand at point of sale with the primary source of the water being a tap derived drinking water from a municipal water source.

The purification process of this embodiment comprises pre-treatment for removal of offending elemental and organic species, and then the enhancement of the water with various intrinsic properties, which include metaphysical properties, taste properties, nutrition properties, and flavoring properties.

An embodiment of the present invention starts first with the verification of the city water source or the tap water source. The water is preferably tested at the point of connection. If the water meets the incoming qualifications, it is used as is in the process. If not, additional treatment steps, including but not limited to, water softening, desalinization, sterilization, and/or microbial screening are preferably used prior to pre-conditioning. The essential goal is to have as high quality standardized water coming into the process to assure the consistency, quality, and cost objectives of the company or of the reseller.

The first step of this process recipe, following the verification, is to treat the water for particulate matter. This is preferably done via wound or membrane type particulate filters. Particles that are five microns or larger would be filtered out at this stage.

The second step of this embodiment comprises utilization of reverse osmosis to remove the total dissolved solids and other colloidal species that are sub five micron. Water then goes through a carbon treatment step. The carbon treatment step is primarily responsible for removing odors and tastes associated with organic species that are not subject to screening through the reverse osmosis membranes. Alternatively, vacuum assisted distillation that known in the art can be employed to purify the dissolved solids in the un-treated water.

The next step in the process comprises treating the water continuously with ultraviolet light. Ultraviolet light creates a sterile environment preventing any airborne organic species from colonizing in the water system which fouls the taste and visual aspects of the water.

Following the ultraviolet step, additional optional measures, such as vapor distillation or ionic/cationic deionization of the water further removes the trace elements from the water and creates a high resistance microsiemens level resistivity in the water. This condition creates a solvent quality in the water. These optional measures also make it much more aggressive in stripping desirable elements into the water stream to create a true natural mineralization from solid materials, such as but not limited to dolamites, limestone, or marble, which are natural formations and natural stones containing desirable minerals.

The next step in the process preferably infuses the water with mineral species, such as but not limited to calcium fluoride, fluoride, lithium, magnesium, potassium, silica, sodium, or many other types of minerals that are found in natural spring waters that contribute to the taste of the water.

The final step of the process filters the infused water by particle filtration. This is preferably sub micron particle filtration to assure that there are no solids in the water or colloidal substances in the water that would result from either the equipment or the process of treating the water with the solid minerals. The final product is then preferably chilled through flash chilling or served with ice in an automatic fashion, for example via an ice maker. Other solids can be introduced into the final product at this stage, such as but not limited to cereal or jelly balls.

In one preferred embodiment, a blend of various types of stones are tested and assayed continuously for consistency. A bed stone that is large enough to provide a consistent supply of minerals to support a commercial distribution of such kind of mineralized water is present in nature.

The composition or constitution of a successful blend is preferably based on the solubility of various stones. By having a serialized and a time driven exposure based on the surface area and dwell time and velocity of the water exposed to the solid stone, the ability to create a well controlled or a tightly controlled consistent process that yields true intrinsic properties based on the minerals in the stone is possible. If the stone is crystalline or has some type of resonance property these properties also contribute to the metaphysical enhancement of the water. All of these processes, however, are completely controlled and are considered proprietary based on the area, compositional selection, and exposure time and are completely proprietary to the supplier of such kind of water treated with this solidified material.

The process disclosed describes a unique method of introducing elements from a solid stone precursor. The consistency of the process can be assured by controlling the various forces and conditions that affect the rate of dissolution of the elements from the solid stone. This is a proprietary solution for this formula but can also be used in a variety of blends and process conditions to create completely new formulations each with unique flavors, mineral properties, and intrinsic and metaphysical qualities. In one embodiment, solid stone materials are used in a serial configuration to control the incidents of exposure during the transportation of the water in the circulation of the filtration system. The other forces that can optionally be applied are temperature, time, pressure, velocity.

Controlling or varying any one of these forces and the composition of the stone creates an entirely new blend and resulting water that is repeatedly produced as long as the source stone is in abundance enough to supply mass markets. The benefits or the attributes for selecting the stone is preferably based on the chemical composition of the materials in the stone formation. A variety of stones can be used sequentially that have varying degrees of hardness and compositional balance for the target minerals. A proprietary recipe can include a single stone with multiple element, composition, or a serial exposure of multiple types of stone to create a blended product from the total composition of the stones used.

Because the stones are found naturally and quarried or mined from places around the world, an added intrinsic value of the stone connected to the place is unique to this process. A stone from Egypt, for example, contributes the intrinsic value of a connection to the ancients. Stones from the mountains of the United States or Canada create an intrinsic value of place associated with the New World. Stones from Asia or India create a connectedness to the eastern philosophical beliefs.

The water of the embodiments above becomes essentially a natural source water created from a place with the exception that the place has been relocated to an automated mechanism that allows nature's forces to be concentrated on the surface of a small area to create the same erosion and the same infusion of the desired minerals as Mother Nature does.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all references, applications, patents, and publications cited above and/or in the attachments, and of the corresponding application(s), are hereby incorporated by reference.

What is claimed is:

1. A method of forming a stackable container comprising:
molding a piece of plastic into a pre-determined container shape;
cutting out the base of the container using a cutting mechanism;
ejecting the container from the mold; and
stacking the container onto a second container.

2. The method of claim 1 wherein the cutting mechanism is a knife.

3. The method of claim 1 further comprising adding contents to the container.

4. The method of claim 3 further comprising sealing the base of the filled container.

5. A stackable bottle comprising:
a bottle having tapered vertical walls to facilitate stacking;
an open bottom to create an annular space facilitating the insertion of one bottle into the other creating a nestable stack;
a threaded spout top; and
a seal cap firmly securing said spout top.

6. The stackable bottle of claim 5 comprising a rounded edge around the bottom of said bottle to allow a sealing material to impress on the edge without tearing through or creating hard edges.

7. The stackable bottle of claim 5 further comprising a seal for sealing said open bottom after contents are added to said bottle.

8. The stackable bottle of claim 7 wherein said seal comprises a laminated foil.

9. The stackable bottle of claim 7 wherein said seal comprises a polymer film.

10. The stackable bottle of claim 7 wherein said seal comprises a co-extruded polymer seal material.

11. A beverage dispensing system comprising:
an automated filtration unit;
an infuser for infusing minerals from a stone material into a beverage;
an inverted single serve container with an open base for dispensing said beverage; and
a roll seal mechanism for sealing said base of said inverted single serve container.

12. The system of claim 11 further comprising an additive infuser for adding flavors to said beverage.

13. The system of claim 11 further comprising an electromagnet for imparting energizing qualities to said beverage.

14. The system of claim 11 further comprising an ice cube maker.

15. The system of claim 11 further comprising a second crystal infuser that allows said beverage to be exposed to both single crystal energy and analog signals of sound and images.

16. The system of claim 11 further comprising a particulate filter downstream of said crystal infuser to assure said beverage is free of any solid materials.

17. The system of claim 11 further comprising a grinding device for grinding said container for recovery and recycling after use.

18. The system of claim 11 further comprising a shredding device for shredding said container for recovery and recycling after use.

19. A method of dispensing a beverage comprising the steps of:
filtering water through an automated filtration unit;
infusing minerals into the water via an infuser;
dispensing the water into an inverted single serve container wherein the base of the container is open;
sealing the container base;
orienting the container so it is upright; and
dispensing the container.

20. The method of claim 19 further comprising adding flavors to the beverage.

21. The method of claim 19 further comprising imparting energizing qualities to the beverage using an electromagnet.

22. The method of claim 19 further comprising adding ice to the beverage.

23. The method of claim 19 further comprising exposing the beverage to analog signals of sound and images.

24. The method of claim 19 further comprising filtering the beverage after the imparting step to ensure no solid particulates are in the beverage.
